(19) United States
(12) Patent Application Publication
(10) Pub. No.: US 2017/0084183 A1
(43) Pub. Date: Mar. 23, 2017

(54) Automatic aircraft separation assurance

(71) Applicant: Robert M. Knox, Geneva, IL (US)

(72) Inventor: Robert M. Knox, Geneva, IL (US)

(21) Appl. No.: 14/858,824

(22) Filed: Sep. 18, 2015

(51) Int. Cl. G08G 5/04; G01C 21/00; G05D 1/10

(52) U.S. Cl. CPC G08G 5/045; G05D 1/101; G01C 21/00

(57) ABSTRACT

The present invention replaces the use of a pilot information display method and instead relies upon an automated three dimensional aircraft tracking system using only aircraft tracking data supplied by internal spherical coverage dual mode sensor system. Separation is accurately predicted and minimum flight path separation (from all nearby aircraft) is automatically assured by signals to the aircraft flight control system without action or intervention by the pilot. When predicted separation is less than minimum separation for the host aircraft, flight control is temporarily removed from the pilot until the automated system redirects the flight path to enable the predicted separation to exceed the minimum separation for the host aircraft. When on-board sensor system predicts separation greater than required minimum, then flight control is returned to the pilot.

### REFERENCES CITED

U.S. Pat. No. 8,744,738 June 2014 Bushwell

This patent describes prediction of flight path for own aircraft and for second aircraft, determines minimum projected separation, but relies on data supplied from external data sources. No description of on-board sensor data to provide tracking data for second aircraft

U.S. Pat. No. 8,380,424 February 2013 Bushwell

This patent describes prediction of flight path for own aircraft and for second aircraft, determines minimum projected separation, but relies on data supplied from external data sources. No description of on-board sensor data to provide tracking data for second aircraft

U.S. Pat. No. 7,706,979 April 2010 Hefferwitz

Data source used for developing tracking predictions and separation are only from outside the aircraft. No description of on-board sensing.

U.S. Pat. No. 7,580,776 August 2009 McCusker

This patent has no description of on board sensor capability, but does use path prediction to project minimum separation. Pilot notified, pilot has final responsibility for collision avoidance.

All current references and published literature for aircraft separation assurance and/or air traffic collision avoidance systems are based on using data supplied by external sources, and/or internal data sources, but wherein pilot (human operator) has ultimate responsibility for air collision prevention (URCP). Pilot's own aircraft flight path control (whether pilot is in cockpit or in a ground station for UAS) is via manual operational control means. Pilot flight path control is optionally aided by automated navigation and flight control systems that collect and employ the referenced external/internal data sources. The pilot is assisted by displays during manual and automated flight control, including those displays associated with an on-board Traffic Collision Avoidance System (TCAS, when that system is installed). Result is that pilot (human) inspection of a display plus exercise of human judgement is required before adequate separation from other aircraft can be achieved for the host aircraft. This shortcoming of existing flight control systems can result in pilot error regarding maintenance of adequate separation and guarantee of collision avoidance at all times. Elevation of the separation assurance (and collision avoidance) probability (to level that is guaranteed) requires the temporary elimination of the human pilot (on the ground or in the cockpit) in the flight control loop. That probability elevation step requires use of an on-board system that is independent of all external sources of traffic control data. Guarantee of automatic separation assurance under the described invention is enabled by incorporation of features that also automatically and continually calibrate and functionally validate reliable system operation. Therefore, the method and system herein described temporarily accepts and guarantees URCP.

The present invention replaces the use of a pilot information display method and instead relies upon an automated three dimensional aircraft tracking system so that separation is accurately measured and minimum flight path separation (from all nearby aircraft) is automatically assured by signals to the aircraft flight control system without action or intervention by the pilot. The pilot will be notified by a display that the automated separation assurance system is temporarily controlling the aircraft flight and the pilot will again be notified when flight control is returned to the pilot. Three dimensional separation tracking is enabled by use of dual sensor modes; that is use of co-bore-sighted high resolution three dimensional radar with two dimensional electro-optical camera. This use of three dimensional tracking assures higher reliability of the separation assurance system and allows the separation assurance and collision avoidance to be automated. This system eliminates any possible pilot error and results in greater air safety for manned or unmanned aircraft. A display showing minimum separation distance (in KM), based upon tracking data and projected flight path for all aircraft in the vicinity is provided at all times to the pilot of a manned aircraft or to the operator of unmanned aircraft. This data provides direct evidence that the system is functional and reliable. This system only removes flight control from the pilot if separation distance is compromised and only for a brief period of time until separation distance is restored to a value higher than the minimum. This automated system operates in virtual real time and has higher probability of preventing collision threat from nearby aircraft that systems that rely on pilot display and pilot decision by eliminating all possibility of human error.

Table of Claims Comparison

| Claim # and Summary | U.S. Pat. No. 8,744,738 | U.S. Pat. No. 7,706,979 | U.S. Pat. No. 7,580,776 |
|---|---|---|---|
| 1 Automatic Separation | Path prediction based on | Path prediction depends | Relies upon external |
| Assurance Sensor suite | externally supplied data | on externally supplied | data inputs to predict |
| uses dual mode sensor | generating commands to | data or use of | aircraft path; collision |
| (radar plus EO/IR | pilot for separation; | transponders (not on all | avoidance depends |
| camera) using only | commands that may be | aircraft) so method is | upon pilot decision, |
| internal sensor to | result in pilot decision | not universal to | which may be in error |
| eliminate pilot error & | error. No spherical sensor. | guarantee collision | based on supplied |
| 2 ASAS | Computer predicts time of | Estimation of time of | No corresponding |
| characterized by | closest approach based | closest approach based | claim |
| on-board dual | on external inputs; no | on stored equations | |
| mode sensor | internal sensor provides | using externally | |
| having spherical | certain data for reliability | supplied data on aircraft | |
| field-of-regard | of such prediction | future path | |
| 3 AASA spherical | Internal hemispherical | Additional cubic | No corresponding |
| coverage by combining | sensors not described | equation but no | claim |
| two opposing | | external sensor to | |
| hemispherical sensor | | assure separation | |
| 4 Multiplicity of on- | Breach of closest | Estimated aircraft | No corresponding |
| board dual mode | approach based on | position vectors | claim |
| sector sensors make | external data, not on- | obtained from external | |
| up the hemispherical | board sensor | sources | |
| 5 On-board Sector | Flight control commands | Air vehicle avoidance | No corresponding |
| sensors are dual mode | generated from external | by pilot flight control | claim |
| using radar and camera | data | using 3D display of | |
| 6 On-board 3D | Computer | Graphic | No on- |
| radar plus 2D | generates | displays for | board |
| video provide | commands | pilot based | sensor |
| data for | based on | on external | claim |
| 7 3D tracking | Computer | Aircraft | No on- |
| provided by processor | alters flight | position | board |
| fusion of outputs from | path based on | vectors | sensor |
| two on-board sensors | externally | determined | claim |
| | supplied data | from | |
| | | [symbol] | |
| 8 Hemispherical | Aircraft maneuver | Estimated closest | No corresponding |
| field-of-regard | altered by flight control | approach by computer | claim |
| provided by | based on externally | from external data for | |
| combining on-board | supplied aircraft | pilot in cockpit or at | |
| sensor output data | position data | ground station of | |
| from sector field-of- | | unmanned aircraft | |
| view for all sectors | | | |
| in the hemisphere | | | |
| 9 Spherical Field- | Commands for | Aircraft position | No corresponding |
| of-Regard | aircraft maneuver | projection and | claim |
| covered by | altered by flight | maneuver altered by | |
| combining | control based on | flight control based | |
| coverage of two | externally supplied | on externally | |
| on-board | aircraft position data | supplied aircraft | |
| [symbol] | | [symbol] | |
| 10 Processor | Separation distance | Estimated closest | No corresponding |
| predicts | prediction is based on | approach by computer | claim |
| minimum | externally supplied | from external data for | |
| separation | position data which may | pilot in cockpit or at | |
| distance from | omit certain nearby | ground station of | |
| on-board sensor | aircraft having lesser | unmanned aircraft but | |
| tracking data for | separation distance | not tracking nearby non- | |
| spherical field- | | cooperating aircraft | |
| of-regard | | | |
| 11 Processor | Pilot makes the decision | Graphic display for pilot | No corresponding |
| temporarily | to change aircraft flight | is used by pilot to | claim |
| disables pilot | if display indicates | enable flight control | |
| flight control if | separation distance is | system to change | |
| separation | less than minimum | direction if separation | |
| distance is | separation distance | distance is below | |
| below minimum | | minimum separation | |
| separation | | distance for host aircraft | |
| distance for | | | |
| [symbol] | | | |
| 12 Cockpit | No indication in claims | 2D or 3D display | No corresponding |
| display provided | that aircraft position and | provides prediction of | claim |
| indicating | minimum separation | separation distance | |
| separation | distance is presented to | computation based on | |
| distance | pilot on a cockpit display | externally supplied data | |
| determined from | | by GPS or other | |
| on-board | | external means | |
| spherical dual | | | |
| mode sensor | | | |
| [symbol] | | | |
| 13 Processor | On board computer | Computer programmed | No corresponding |
| commands from | sends commands for | to reduce the delta | claim |
| on-board sensor | flight maneuver based | separation using | |
| to flight control | on data provided by | external data from | |
| enable reduction | external sources | satellite or other | |
| in predicted | | sources | |
| separation | | | |
| 14 Pilot display | Pilot has flight control at | Computer programmed | No corresponding |
| indicator that | all times and makes any | to reduce predicted path | claim |
| pilot flight | decision to avoid | delta using externally | |
| control has been | possible collision. Pilot | supplied location data | |
| disabled when | error is not removed as | for host and other | |
| predicted | possible cause for | aircrafts. Pilot controls | |
| minimum | collision | flight path | |
| separation has | | | |
| been breached | | | |
| 15 When | Separation module | Computer estimates air | No corresponding |
| predicted | provides prediction of | vehicle position for | claim |
| separation | separation for the pilot | cockpit display enabling | |
| exceeds | who retains flight control | pilot to operate flight | |
| minimum | based on externally | controls to avoid | |
| separation then | supplied location data. | collision. Possible pilot | |
| pilot control is | Collision can result from | error is not avoided | |
| restored based | pilot error or unreliable | | |
| on data from on- | external data | | |
| [symbol] | | | |

[symbol]

indicates data missing or illegible when filed

### TECHNICAL FIELD

The invention relates to the field of avionics airborne flight safety and in particular to an apparatus and method for automatic air vehicle separation assurance (and collision avoidance) that eliminates any possibility for pilot error aboard a host aircraft (or at ground station for unmanned aircraft) or failure of external flight traffic control systems data input. Elimination of pilot or human error potentially elevates aircraft, separation assurance, collision avoidance and aviation safety to a new level for manned and unmanned aircraft.

### BRIEF DESCRIPTION OF THE DRAWINGS

FIG. 1 is a drawing of an aircraft in which forward and rearward hemispherical, 4Pi steradians, field-of-regard (180 degrees by 180 degrees) are shown along with indication of a small conical sector field-of-view (about 30 degrees by 30 degrees)

FIG. 2 is drawing of a hemispherical subsystem indicating separate conical sectors covering the entire 2Pi field-of-regard.

FIG. 3 is a block diagram for the Automatic Aircraft Separation Assurance sensor suite system

### DETAILED DESCRIPTION OF THE INVENTION

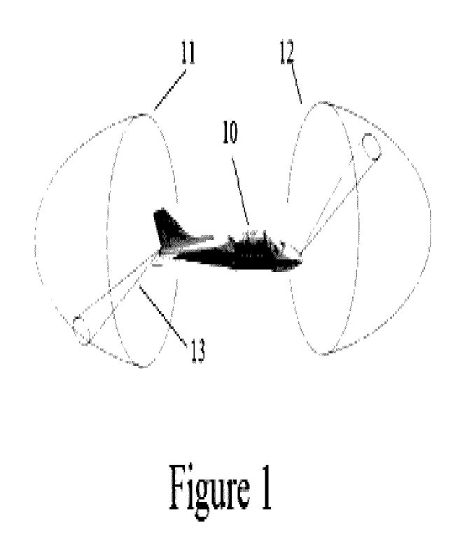

A sensor suite for a host aircraft (10) extends the field-of-regard to full spherical coverage, 4Pi steradians. The method and apparatus makes use of two hemispherical sensor subsystems as shown in FIG. 1. A first hemispherical subsystem field-of-regard (12) is directed forward of the aircraft (10) while a second hemispherical subsystem field-of-regard (11) is directed to the rear. Each hemispherical subsystem field-of-regard is composed of many instantaneous search sectors (13) each operating a dual mode sensor for detecting, tracking and characterizing other aircraft.

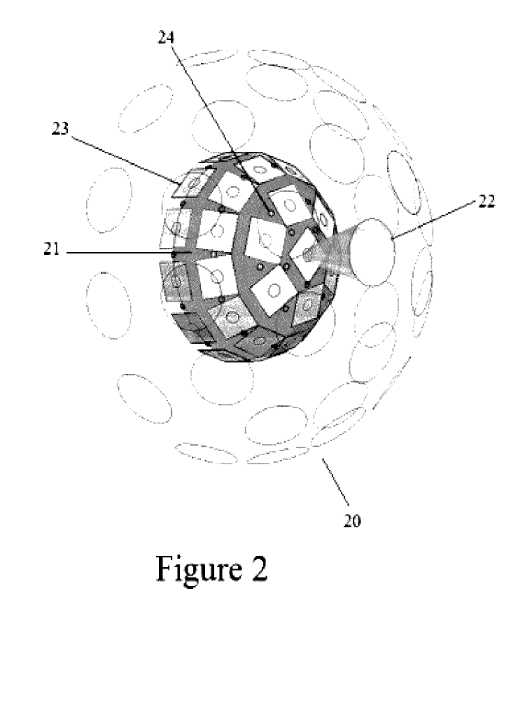

Drawing of an exemplary dual mode sensor hemispherical subsystem (20) is shown in FIG. 2. Individual sector conical fields-of-view (22) for radar sensor and EO/IR camera are positioned over a conical surface (21). One radar antenna option is a flat patch array (23), however, alternative antenna types include horn, horn-lens, etc. EO/IR camera apertures (24) share the field-of-view sector with a radar sensor antenna (23) and are typically co-boresighted with a radar beam.

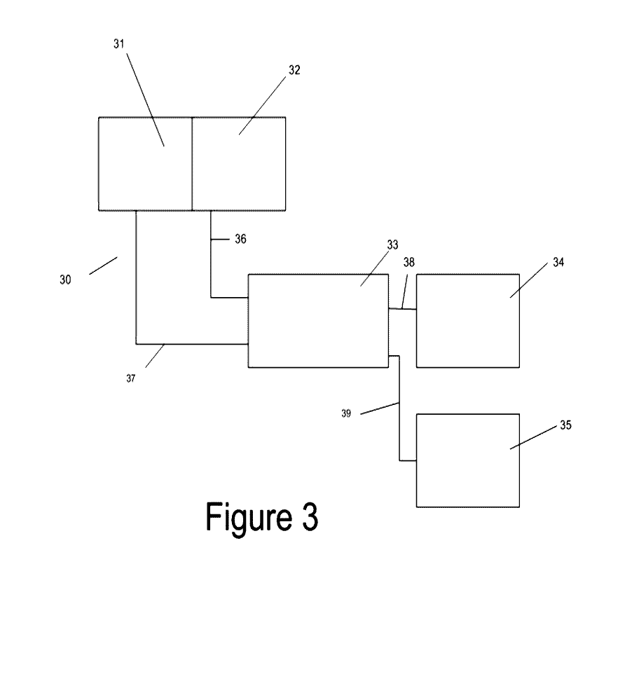

A block diagram for the spherical coverage dual mode automatic aircraft separation assurance system (30) is presented in FIG. 3. A forward-directed hemispherical sensor subsystem (32) and a rear-directed hemispherical sensor subsystem (31) are indicated. Output (36) of forward-directed hemispherical subsystem (32) is connected to processor (33). Output (37) of rear-directed hemispherical subsystem (31) is connected to processor (33). Output (38) of the processor (33) is connected to the pilot display (34). A second output (39) of the processor (33) is connected to the host aircraft flight control system (35).

What I claim is:

1. Automatic Aircraft Separation Assurance apparatus and method disposed aboard a host aircraft requiring minimum separation distance, said apparatus including a sensor suite, processor, separation assurance algorithms and pilot display, said method detecting and tracking all aircraft in the spherical field-of-regard of said host aircraft, said processor predicting said host aircraft separation distance, said pilot display informing pilot of predicted separation distance, said pilot display alerting pilot if flight control is removed from the pilot. Said processor operating said separation assurance algorithms on said sensor suite tracking data predicting said host vehicle tracking separation below specified minimum separation for said host aircraft, said AASA apparatus temporarily suspending pilot flight control, supplies direction/altitude commands to said host aircraft flight control system, indicates via said pilot display suspension of pilot flight control. Said direction/altitude commands enable increased tracking separation of said host aircraft to exceed said minimum separation distance. Said sensor suite track data processor separation assurance algorithms return pilot flight control when said separation distance exceeds said minimum separation distance.

2. The AASA apparatus of claim 1 further characterized by dual mode sensor suite for detection and tracking of aircraft in said spherical field-of-regard of said host aircraft.

3. The AASA apparatus of claim 1 further characterized by said dual mode sensor suite having first hemispherical dual mode sensor subsystem mounted and aligned with said host vehicle flight path direction plus second hemispherical dual mode sensor subsystem aligned with said first hemispherical dual mode sensor directed opposing said flight path direction.

4. The AASA apparatus of claim 1 further characterized by said hemispherical dual mode sensor subsystem consisting of a multiplicity of dual mode sector sensors arrayed on a hemispherical surface.

5. The AASA apparatus of claim 1 further characterized by said dual mode sector sensors covering a specified angular sector field-of-view of said hemispherical field-of-regard.

6. The AASA apparatus of claim 1 further characterized by said dual mode sector sensor consisting of three dimensional radar sensor disposed and aligned with two dimensional electro-optical video sensor sharing said sector field-of-view.

7. The AASA apparatus of claim 1 further characterized by said processor fusing output of said three dimensional radar sensor with output of said two dimensional electro-optical sensor to provide three dimensional tracking data for all detected aircraft in said sector field-of-view of said hemisphere field-of-regard.

8. The AASA apparatus of claim 1 further characterized by said processor combining three dimensional tracking data for said host aircraft in said sector field-of-view with three dimensional tracking data for said aircraft from all said dual mode sensor sectors in said first hemispherical field-of-regard.

9. The AASA apparatus of claim 1 further characterized by said processor three dimensional tracking data for said host aircraft spherical field-of-regard combining three dimensional tracking data for first hemispherical field-of-regard with three dimensional tracking data for said host aircraft second hemispherical field-of-regard.

10. The AASA apparatus of claim 1 further characterized by said processor predicting minimum separation distance enabled by said separation assurance algorithms operating on said three dimensional tracking data in said spherical field-of-regard.

11. The AASA apparatus of claim 1 further characterized by said processor temporarily disabling pilot flight control when said predicted separation distance is below said minimum separation distance for said host aircraft.

12. The AASA apparatus of claim 1 further characterized by said cockpit display of said predicted separation distance.

13. The AASA apparatus of claim 1 further characterized by said processor commands to said flight control system enabling change in said host aircraft direction and/or altitude to reduce predicted separation distance.

14. The AASA apparatus of claim 1 further characterized by said cockpit display indicator that pilot flight control has been disabled because said aircraft minimum separation distance has been breached.

15. The AASA apparatus of claim 1 further characterized by said cockpit display that pilot flight control has been restored when said minimum separation distance predicted by said processor has been exceeded.
